(19) United States
(12) Patent Application Publication
(10) Pub. No.: US 2007/0041777 A1
(43) Pub. Date: Feb. 22, 2007

(54) Magnetic spring clip and system

(76) Inventor: Dan L. Dietz, Houston, TX (US)

Correspondence Address: DARCELL WALKER, 8107 CARVEL LANE, HOUSTON, TX, 77036, US

(21) Appl. No.: 11/208,494

(22) Filed: Aug. 22, 2005

(51) Int. Cl. B43K 5/16; B43K 23/02

(52) U.S. Cl. 401/131; 401/195

(57) ABSTRACT

A magnetic spring clip device is designed that attaches to a writing instrument, lighting instrument, or any other similar type device. The invention further provides a magnetic spring clip system that enables a person to better secure various types of instruments to the person's clothing. In this system, a magnet attached to the arm of the spring clip forms an attraction to a magnet housed in the instrument. This magnetic attraction causes the magnets to come together thereby securing any material inserted between the magnets.

### FIELD OF THE INVENTION

This invention relates to a device for securing writing or other instruments on a person's clothing and in particular, this invention relates to a magnetic spring clip that securely engages a pocket or other area on the clothing of an individual. This engagement of the individual's clothing magnetically secures the particular instrument to the individual. The magnetic instrument can be part of a combined system for securing multiple instruments to a person's clothing.

### BACKGROUND OF THE INVENTION

Written communications have been a primary means of communication dating back to the medieval period. As early as the 4^{th} century, people used crude writing instruments to communicate information. These instruments consisted of hollow straws or reeds that supported a short column of liquid. During the fifth century, people began to make pens formed from wing feathers. Currently, the writing pen has evolved into a variety writing instruments, which include: the ballpoint pen, the fountain pen, the soft-tip pen lettering pin and the technical pin. Today, pens rank among the most widely used writing instrument.

Writing instruments have also contained clips used to secure the instrument to the clothing of the user. U.S. Pat. No. 5,152,626 describes a writing instrument that includes a clip, which can be retracted into an opening of a barrel, and an operating unit, which has a pushbutton and an operating cam. The writing instrument can be operated by a single operating means, while the clip can function only when the writing cartridge is retracted.

U.S. Pat. No. 6,685,374 describes a spring biased clip design. This clip assembly is securably affixable to the body of a variety of hand-held implements, including writing devices, which is capable of clasping objects substantially thicker that a garment pocket, such as notepads, books, and backpacks. The clip assembly comprises a pin securably engaged to the body of the hand-held implement, a rigid member having a first end for clasping an article, and a second end for manually operating the clip assembly, and a spring biasing the first end of the rigid member towards the body of said hand-held writing implement.

U.S. Pat. No. 6,499,196 describes a clip for a writing instrument has an external biasing mechanism separate from the connection of the clip to the writing instrument to avoid permanent deformation or breaking of the clip arm and wear on the writing instrument body. The biasing mechanism is a coil spring mounted on the clip arm between two supports for compression and flexion when the clip arm is pulled away from the side of the writing instrument.

There remains a need for an improved spring clip mechanism for securing a linear writing, lighting or other instrument to a person's clothing without adverse effects to the clothing item that supports the instrument attached to it.

### SUMMARY OF THE INVENTION

It is an objective of the present invention to provide a magnetic spring clip that enable a person to better secure writing and/or lighting instruments to the person's clothing.

It is a second objective of the present invention to provide a magnetic spring clip system having a magnetic contained within the writing or lighting instrument and having a magnetic clip arm.

It is a third objective of the present invention to provide a magnetic spring clip system that is attachable to and detachable from a writing instrument or a lighting instrument.

It is a fourth objective of the present invention to provide a magnetic spring clip that attaches to a combined illuminated writing instrument system.

The present invention provides a magnetic spring clip device that is attachable to a writing instrument, lighting instrument, an illuminating writing instrument or any other similar type device. The invention further provides a magnetic spring clip system that enables a person to better secure various types of instruments to the person's clothing.

The magnetic spring clip of the present invention comprises a clip base that attaches to the instrument. This base further comprises a pivot point to enable the spring clip to rotate between open and closed positions to engage the clothing article. The pivot point comprises a hinge that also attaches a clip shaft to the clip base. A clip magnet attaches to the clip shaft. The magnetic force of the magnetic attaches to the external surface of the instrument pinning a portion of the article of clothing between the magnet and the surface of the instrument and therefore securing the instrument via the magnetic spring clip to the clothing article. The ability of the clip shaft and clip magnet to pivot between open and closed provides an opening through which clothing is inserted. As mentioned in the closed position the magnet clamps against the clothing and thereby secures the instrument to the clothing article.

The system of the present invention comprises the magnetic spring clip device attached to an instrument such as a writing pen or a flashlight. Within the instrument is an internal magnet. The position of this magnet within the instrument is such that the internal is aligned with the clip magnet when the clip is in the closed position. In operation, the magnetic fields of the magnets cause the magnetic to attach to each other. This magnetic attraction causes the clip shaft to move to the instrument. This movement places the magnetic clip in the closed position, which secures the instrument to the article of clothing.

### DESCRIPTION OF THE DRAWINGS

FIG. 1 is a side and bottom view of the magnetic spring clip device of the present invention attached to a linear flash light instrument.

FIG. 2 is an exploded view of the magnetic spring clip device of the present invention.

FIG. 3 is an illustration of the concept of the magnetic spring clip system of the present invention with the magnetic clip in the closed position.

FIG. 4 is an illustration of the concept of the magnetic spring clip system of the present invention with the magnetic clip in the open position.

FIG. 5a is a side view of the magnetic spring clip system of the present invention.

FIG. 5b is a side cross-sectional view of the magnetic spring clip system of the present invention.

FIG. 6a is a side view of the pivot mechanism of the magnetic spring clip of the present invention.

FIG. 6b is a side cross-section view of the pivot mechanism of the magnetic spring clip of the present invention.

FIG. 7 is a front, side and top view of an embodiment of the magnetic spring system of the present invention implemented with an illuminated writing instrument.

FIG. 8 is a front, side and top view of an alternate embodiment of the magnetic spring system of the present invention implemented with an illuminated writing instrument.

FIG. 9 is a front, side and top view of an alternate embodiment of the magnetic spring system of the present invention attached to a dual clip.

### DETAILED DESCRIPTION OF THE INVENTION

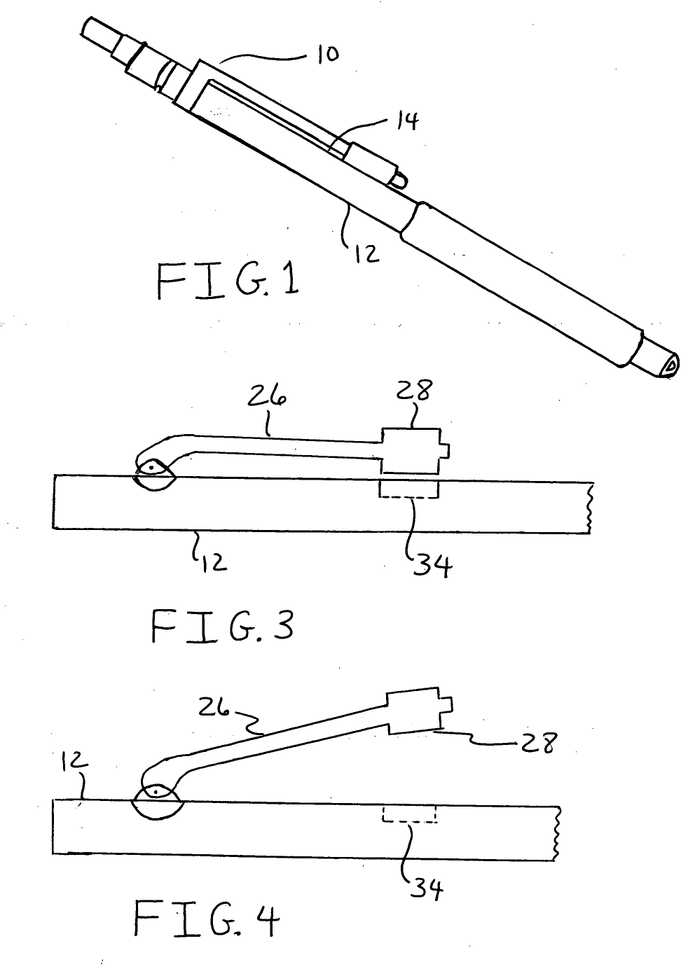

The present invention describes a magnetic spring clip and system for securing instruments to a person's clothing or other objects or devices. FIG. 1 shows an embodiment of the present invention implemented on a flashlight instrument. As shown, a spring clip 10 is attached to the flashlight instrument 12. The attachment of the clip to the instrument as designed in this invention produces a small opening 14 between a portion of the clip and the instrument. Through this opening, a portion of the device is inserted to enable the securing of the device with the magnetic spring clip.

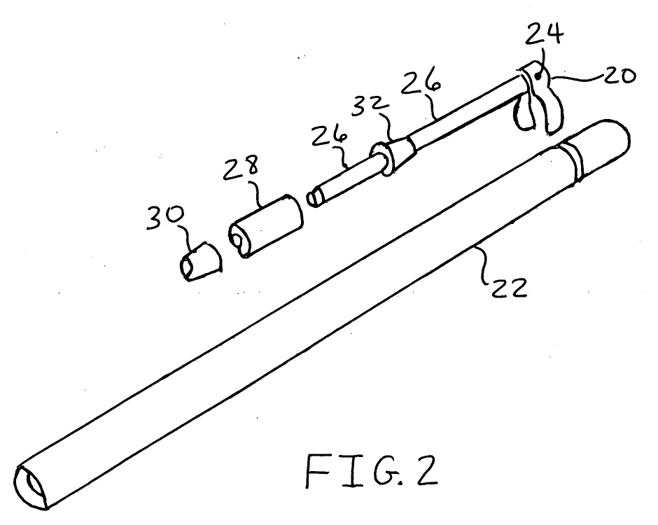

FIG. 2 shows an exploded view of the magnetic spring clip system. The magnetic spring clip comprises a clip base 20. This base can have a semi-circle design such that an opening exists on one side. This opening enables the clip base to receive and attach to an instrument 22. The clip further comprises a pivot point 24 that attaches the clip base to a clip arm (shaft) 26 and enables that clip arm to rotate a certain degrees from and toward the instrument. The clip arm can further have a threaded end away from the pivot point end of the shaft. These thread provide a means to attach a clip magnet 28 to the clip arm 26. In an alternate embodiment, the magnet can be a slide on magnetic. In this embodiment, an end cap 30 can attach to the shaft via these threads to serve as a magnet stop. A second stop 32 is also positioned on the shaft above the magnet. These two stops help secure and prevent movement of the magnetic 28. As mentioned, there can be various types of instruments 22 to which one can attach the magnetic spring clip. One such instrument can be a writing instrument with a magnetic clip as described in U.S. patent application Ser. No. 10/907,734. Another instrument include could be magnetic flashlight such as the one described in U.S. patent application Ser. No. 10/908,108. Both applications invented by the present inventor.

The system of FIG. 2 does not reveal the magnet internal to the flashlight or writing instrument. In one embodiment, the arm 26 can be of a magnetic material. Further the instrument surface can also be of a metal or magnetic material. In this embodiment, the magnetic force of the arm would cause the arm to be attracted to the surface of the instrument. In a preferred embodiment, the instrument would contain an internal magnet 34 that is aligned such that it's magnetic field forms an attraction to the magnetic field of the magnet 28 on the clip arm 26.

FIGS. 3 and 4 conceptually show the different positions of the magnetic spring clip system of the present invention. FIG. 3 shows the magnetic spring system in the closed position. This position is the normal or default position of the magnetic spring clip. In this position, the magnet 28 from the clip attracts to the internal magnet 34. The attraction force (magnetic attraction) draws the clip magnet towards the internal magnet and instrument surface. The clip magnetic will in many cases actually contact the instrument surface to provide the clamping action that holds anything inserted into the process to secure the instrument to the desire object.

FIG. 4 shows the position of the magnetic device in the open position. In this position, the clip arm is positioned at a distance from the instrument. However, because of the magnetic attraction between the clip and internal magnets, it is necessary to apply force to the clip arm to overcome the magnetic attraction of the magnets in order to position the spring magnet in the open position. In the open position, material to which it is desired to attach the instrument 12 is inserted between the instrument surface 1.2 and the clip arm 26. At the release of the arm, the magnetic force will cause the arm and to rotate toward and move the clip magnet toward the internal magnet 34, thereby clamping the inserted material and securing the instrument via the magnetic spring clip to the material.

FIG. 5a shows a side view of the magnetic spring clip system of the present invention in the closed position. The system shows an embodiment of the pivot point 24. Also shown is an illustration of a tapered top switch 40. This switch is used to turn on and turn off the light source for a lighting instrument. For a writing instrument, this switch can advance and retract the writing element of a writing instrument.

FIG. 5b is a side cross-sectional view of the magnetic spring clip system of the present invention. This embodiment is one in which the magnetic spring clip is attached to a lighting instrument. In addition to the elements of the magnetic clip system, contained within this lighting instrument is a pair of batteries 42 and 44. The internal magnet 34 is positioned between the two batteries. At the lower end of the lighting instrument is the light bulb 46. The switch 40 can be a rotating switch as shown or a push switch. In the implementation of the invention, the internal magnet does not interfere in any way with the operation of the batteries or electrical functions of the lighting instrument.

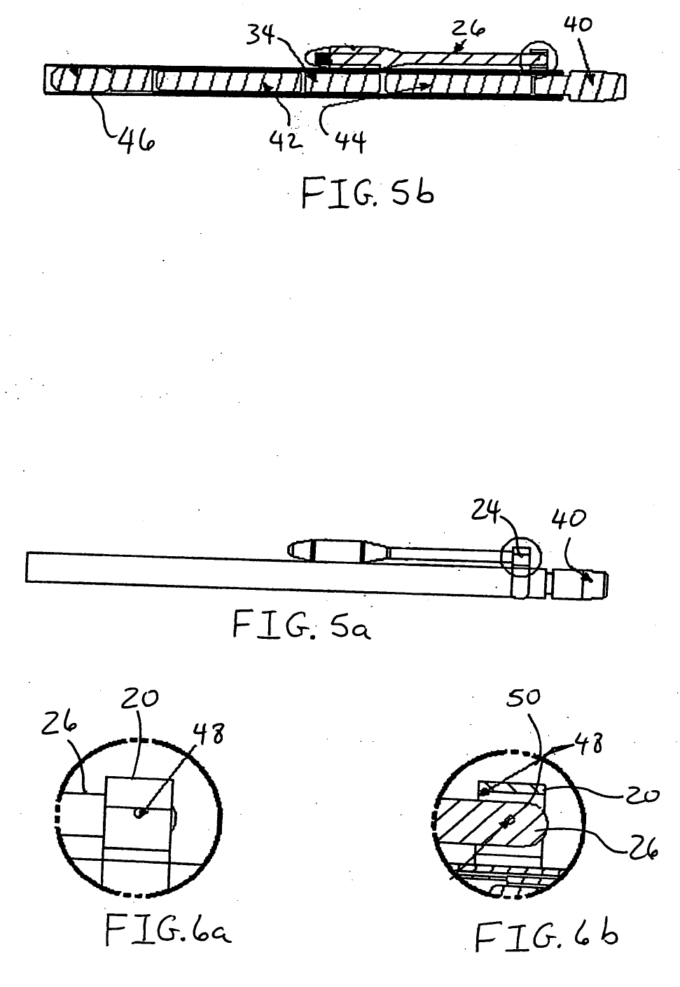

FIG. 6a is a side view of the pivot mechanism of the magnetic spring clip of the present invention. In the pivot point mechanism, the pivot rod 48 extends through the clip arm and attaches to the side of the clip base 20. The clip arm 26 can be positioned in the clip base to give greater flexibility and degrees for positioning the arm in the open position. The extension of the more of the arm toward the switch of the instrument will restrict the degrees of the opening position. In FIG. 6b, the amount of space 50 between the clip base 20 and shaft 26 also allows for the limited movement of the clip arm. The closer the arm is the top of the base, the smaller the movement of the arm.

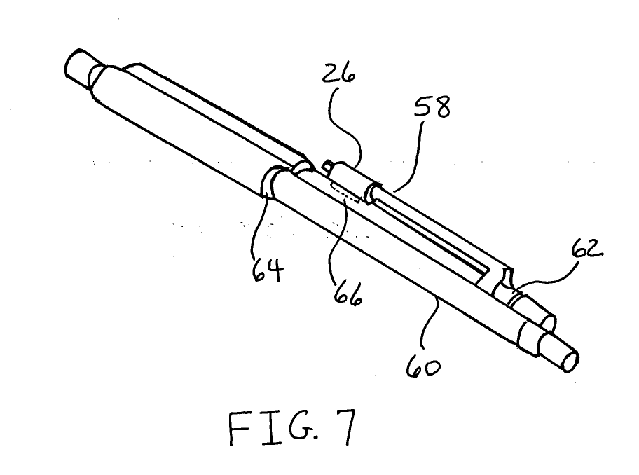

FIG. 7 is a front, side and top view of an embodiment of the magnetic spring system of the present invention implemented with an illuminated writing instrument. In this embodiment, the magnet clip system 58 of the present invention is implemented in an improved illuminated writing instrument comprises a writing element 60, a lighting element 62 and an attaching element 64. The lighting element contains the internal magnet 66 of the magnetic spring clip of the present invention. The clip magnet 26 attracts to the internal magnet 58. The writing and lighting elements are secured to each other via the attaching element described in U.S. patent application Ser. No. 11/112,260 which is owned by the present inventor. The writing and lighting are secured to each other through openings in the attaching element. The attaching element has an exterior surface formed of elastic grippers that provide increased stability between the user and the writing instrument. The attaching element also has the capability to alter its shape in response to pressure from the user's fingers. The capability to alter the shape of the attaching element enables the user to easily and comfortably hold the writing instrument.

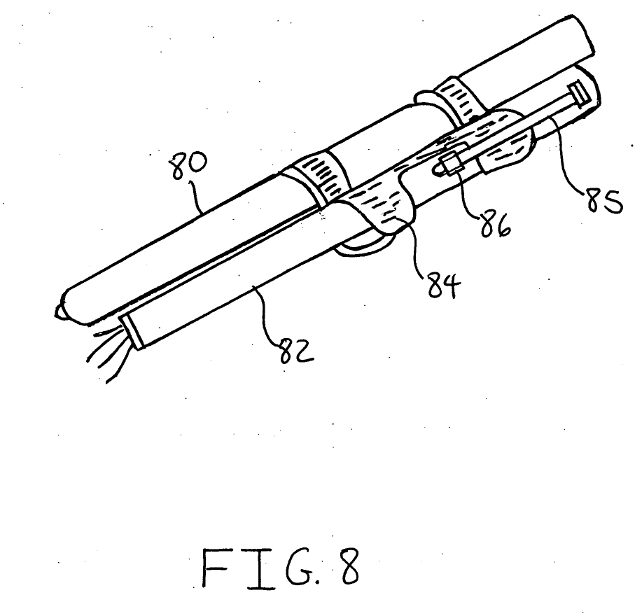

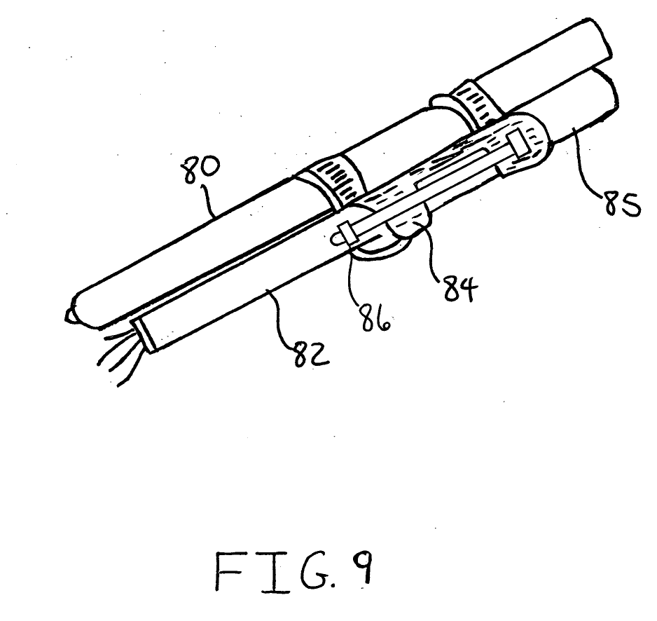

FIG. 8 is a front, side and top view of an alternate embodiment of the magnetic spring system of the present invention implemented with an illuminated writing instrument. In this embodiment, the magnet clip system of the present invention is implemented in an improved illuminated writing instrument comprises a writing element 80, a lighting element 82 and an attaching element 84. The writing and lighting elements are secured to each other via the attaching element, described in U.S. patent application Ser. No. 11/120,687 which is owned by the present inventor. The attaching element comprises a combination dual clip. A dual opening clip attaches the writing instrument and the illuminating instrument such that the two instruments form one illuminated writing instrument. The invention further comprises a magnetic spring clip 85 to secure the illuminated writing instrument as desired by the user. In operation, the force from the magnetic field of the spring magnet 86 attracts to the internal magnet in the lighting instrument. This attraction will draw the spring magnet to the internal magnet. The attachment of these magnets will secure the arm to the magnet thereby creating the mechanism that will provide the securing capabilities of the magnetic spring clip. This clip will have the capability of securing the illuminated writing instrument as desired by the user.

FIG. 9 is a front, side and top view of an alternate embodiment of the magnetic spring system of the present invention attached to a dual clip. The spring clip base 85 attaches to the dual clip 84. As with FIG. 8, in operation, the force from the magnetic field of the spring magnet 86 attracts to the internal magnet in the lighting instrument. This attraction will draw the spring magnet to the internal magnet. In this embodiment, the arm can extend over the dual clip.

The present invention provides significant advantages over the current art. While the invention has been described using a limited number of embodiments, those skilled in the art, having the benefit of this disclosure, will appreciate that other variations are possible without departing from the scope of the invention as disclosed herein or from its true spirit. Accordingly, the scope of the invention should be limited only by the attached claims.

This description is intended for purposes of illustration only and should not be construed in a limiting sense. Only the language of the claims that follow should determine the scope of this invention. The term “comprising” within the claims is intended to mean “including at least” such that the recited listing of elements in a claim are an open group. “A,” “an” and other singular terms are intended to include the plural forms thereof unless specifically excluded.

I claim:

1. A magnetic spring clip comprising:
a clip base having a semi-circled shape with an opening for engaging an instrument;
a pivot point within said clip base;
a shaft having a generally linear shape and upper and lower ends, the upper end of said shaft being attached to said clip base by said pivot point such that said shaft is moveable relative to the clip base, said shaft further comprises a magnetic lower end, the magnetic lower end being magnetically attracted to the instrument such that the lower end of the shaft contacts the instrument and secures any material between the lower end of said shaft and the instrument.

2. The magnetic spring clip as described in claim 1 wherein the lower magnetic end of said shaft further comprises a clip magnet secured to the end of said shaft.

3. The magnetic spring clip as described in claim 2 wherein said magnet is screwably secured to said shaft.

4. The magnetic spring clip as described in claim 2 wherein said magnet is slideably secured to said shaft.

5. The magnetic spring clip as described in claim 4 further comprising upper and lower caps attached to said shaft and positioned such that said magnet is secured to said by said upper and lower caps.

6. The magnetic spring clip as described in claim 1 wherein said clip base has walls, an upper side and an opening to receive said shaft.

7. The magnetic spring clip as described in claim 6 wherein said pivot point further comprises a pivot rod extending across the opening and attached to walls of said clip base.

8. The magnetic spring clip as described in claim 7 wherein said pivot rod extends through the upper end of said shaft thereby attaching said shaft to said clip base.

9. A magnetic spring clip system comprising:
an instrument having a generally linear shape;
a clip base having a semi-circled shape with an opening for engaging said instrument;
a pivot point within said clip base;
a shaft having a generally linear shape and upper and lower ends, the upper end of said shaft being attached to said clip base by said pivot point such that said shaft is moveable relative to the clip base, said shaft further comprises a magnetic lower end, the magnetic lower end being magnetically attracted to the instrument such that the lower end of the shaft contacts the instrument and secures any material between the lower end of said shaft and the instrument; and
a magnet housed inside said instrument and aligned to magnetically attract said shaft.

10. The system as described in claim 9 further comprising a second instrument having a generally linear shape.

11. The system as described in claim 10 further comprising a mechanism that attaches the instrument to said second instrument.

12. The system as described in claim 11 wherein said attaching mechanism is a dual clip.

13. The system as described in claim 11 wherein said attaching mechanism is a rubber grummet.

14. A magnetic spring clip system comprising:
a pair of instruments having a generally linear shapes;
a clip for attaching said pair of instruments
a clip base having a semi-circled shape with an opening for engaging at least one instrument of said pair of instruments;
a pivot point within said clip base; and
a shaft having a generally linear shape and upper and lower ends, the upper end of said shaft being attached to said clip base by said pivot point such that said shaft is moveable relative to the clip base, said shaft further comprises a magnetic lower end, the magnetic lower end being magnetically attracted to the instrument such that the lower end of the shaft contacts the instrument and secures any material between the lower end of said shaft and the instrument.

15. The magnetic clip system as described in claim 15 further comprising a magnet housed inside said instrument and aligned to magnetically attract said shaft.

16. The magnetic clip system as described in claim 15 wherein said clip base engages said instrument by engaging said clip for attaching said pair of instruments.
